(19) United States
(12) Patent Application Publication
(10) Pub. No.: US 2008/0280184 A1
(43) Pub. Date: Nov. 13, 2008

(54) FUEL CELL, METHOD FOR MANUFACTURING FUEL CELL, AND ELECTRONIC APPARATUS

(75) Inventors: Hideki Sakai, Kanagawa (JP); Takashi Tomita, Kanagawa (JP); Atsushi Sato, Kanagawa (JP); Takaaki Nakagawa, Kanagawa (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 12/116,657

(22) Filed: May 7, 2008

(30) Foreign Application Priority Data
May 8, 2007 (JP) 2007-123795

(51) Int. Cl. H01M 4/90; H01M 8/02

(52) U.S. Cl. 429/34; 429/40; 29/623.1

(57) ABSTRACT

A fuel cell includes a positive electrode and a negative electrode which are opposed to each other with a proton conductor provided therebetween, and an enzyme immobilized as a catalyst on at least one of the positive and negative electrodes. In the fuel cell, the positive electrode, the proton conductor, and the negative electrode are accommodated in a space formed between a positive electrode current collector having a structure permeable to an oxidizer and a negative electrode current collector having a structure permeable to fuel.

### CROSS REFERENCES TO RELATED APPLICATIONS

The present application claims priority to Japanese Patent Application JP 2007-123795 filed in the Japanese Patent Office on May 8, 2007, the entire contents of which are incorporated herein by reference.

### BACKGROUND

The present application relates to a fuel cell including an enzyme immobilized as a catalyst on at least one of a positive electrode and a negative electrode, a method for manufacturing the fuel cell, and an electronic apparatus using the fuel cell.

Fuel cells have a structure in which a positive electrode (oxidizer electrode) and a negative electrode (fuel electrode) are opposed to each other with an electrolyte (proton conductor) provided therebetween. In a fuel cell of related art, fuel (hydrogen) supplied to a negative electrode is decomposed into electrons and protons (H⁺) by oxidation, the electrons are supplied to the negative electrode, and H⁺ moves to the positive electrode through the electrolyte. On the positive electrode, H⁺ reacts with oxygen supplied from the outside and the electrons supplied from the negative electrode through an external circuit to produce H₂O.

Therefore, a fuel cell is a high-efficiency generating apparatus which directly converts chemical energy possessed by fuel to electric energy, and is capable of utilizing, with high efficiency, electric energy from chemical energy possessed by fossil fuel, such as natural gas, petroleum, and coal, regardless of an operation place and operation time. Consequently, fuel cells have been actively researched and developed as applications to large-scale power generation. For example, an actual performance has proved that a fuel cell provided on a space shuttle can supply electric power and water for crews and is a clean generating apparatus.

Further, fuel cells such as solid polymer-type fuel cells, which show a relatively low operation temperature range from room temperature to about 90° C., have recently been developed and attracted attention. Therefore, not only application to large-scale power generation but also application to small systems such as driving power supplies of automobiles and portable power supplies of personal computers and mobile devices are being searched for.

Thus, fuel cells are widely used for applications including large-scale power generation and small-scale power generation and attract much attention as high-efficiency generating apparatuses. However, fuel cells generally use, as fuel, natural gas, petroleum, or coal which is converted to hydrogen gas by a reformer, and thus have various problems of the consumption of limited resources, the need to heat to a high temperature, the need for an expensive noble metal catalyst such as platinum (Pt), and the like. In addition, even when hydrogen gas or methanol is directly used as fuel, it is desired to take caution to handling thereof.

Therefore, attention is paid to the fact that biological metabolism in living organisms is a high-efficiency energy conversion mechanism, and its application to fuel cells has been proposed. The biological metabolism includes aspiration and photosynthesis taking place in microorganism cells. The biological metabolism has the characteristic that the generation efficiency is very high, and reaction proceeds under mild conditions such as room temperature.

For example, aspiration is a mechanism in which nutrients such as saccharides, fat, and proteins are taken into microorganisms or cells, and the chemical energy thereof is converted to oxidation-reduction energy, i.e., electric energy, by a glycolytic system including various enzyme reaction steps, and a process of producing carbon dioxide (CO₂) through a tricarboxylic acid (TCA) cycle, in which nicotinamide-adenine dinucleotide (NAD) is reduced to reduced nicotinamide-adenine dinucleotide (NADH). Further, in an electron transfer system, the electric energy of NADH is converted directly into proton gradient electric energy, and oxygen is reduced, producing water. The electric energy obtained in this mechanism is utilized for producing ATP from adenosine diphosphate (ADP) through an adenosine triphosphate (ATP) synthetase, and ATP is used for a reaction necessary for growing microorganisms or cells. Such energy conversion takes place in plasmasol and mitochondoria.

In addition, photosynthesis is a mechanism in which light energy is taken in, and water is oxidized to produce oxygen by a process of converting to electric energy by reducing nicotinamide-adenine dinucleotide phosphate (NADP⁺) to reduced nicotinamide-adenine dinucleotide phosphate (NADPH) through an electron transfer system. The electric energy is utilized for a carbon immobilization reaction in which CO₂ is taken in to synthesize carbohydrates.

As a technique for utilizing the above-mentioned biological metabolism in a fuel cell, there has been reported a microbial cell in which electric energy generated in microorganisms is taken out from microorganisms through an electron mediator, and the electrons are supplied to an electrode to produce a current (refer to, for example, Japanese Unexamined Patent Application Publication No. 2000-133297).

However, there are many unnecessary reactions other than the desired reaction for converting chemical energy to electric energy in microorganisms and cells, and thus chemical energy is consumed for an undesired reaction in the above-described method, thereby failing to exhibit a sufficient energy conversion efficiency.

Therefore, there have been proposed fuel cells (biofuel cells) in which only a desired reaction is effected using an enzyme (refer to, for example, Japanese Unexamined Patent Application Publication Nos. 2003-282124, 2004-71559, 2005-13210, 2005-310613, 2006-24555, 2006-49215, 2006-93090, 2006-127957, 2006-156354, and 2007-12281). As the biofuel cells, there have been developed biofuel cells in which fuel is decomposed into protons and electrons by an enzyme, an alcohol such as methanol or ethanol, a monosaccharide such as glucose, or a polysaccharide such as starch being used as the fuel.

FIGS. 8A and 8B show an example of a configuration of a biofuel cell of related art (refer to, for example, Japanese Unexamined Patent Application Publication Nos. 2006-24555 and 2006-127957). As shown in FIGS. 18A and 18B, the biofuel cell includes a negative electrode 101 composed of an enzyme/electron mediator immobilized carbon electrode in which an enzyme and an electron mediator are immobilized on, for example, porous carbon with an immobilizing material, and a positive electrode 102 composed of an enzyme/electron mediator immobilized carbon electrode in which an enzyme and an electron mediator are immobilized on, for example, porous carbon with an immobilizing material, the negative and positive electrodes 101 and 102 being opposed to each other with an electrolyte layer 103 provided therebetween. In this case, Ti current collectors 104 and 105 are disposed below the positive electrode 102 and the negative electrode 101, respectively, for collecting current. Reference numerals 106 and 107 each denote a fixing plate. The fixing plates 106 and 107 are fastened together with screws 108 so that the negative electrode 101, the positive electrode 102, the electrolyte layer 103, and the Ti current collectors 104 and 105 are sandwiched between the fixing plates 106 and 107. In addition, a circular recess 106a for air intake is provided on one (outer side) of the surfaces of the fixing plate 106, and many holes 106b are provided at the bottom of the recess 106a so as to pass to the other surface. These holes 106b serve as air supply passages to the positive electrode 102. On the other hand, a circular recess 107a for fuel charge is provided on one (outer side) of the surfaces of the fixing plate 107, and many holes 107b are provided at the bottom of the recess 107a so as to pass to the other surface. These holes 107b serve as fuel supply passages to the negative electrode 101. Further, a spacer 109 is provided on the periphery of the other surface of the fixing plate 107 so that the fixing plates 106 and 107 are fastened together by the screws 108 with a predetermined space therebetween.

As shown in FIG. 18B, in the biofuel cell, a load 110 is connected between the Ti current collectors 104 and 105, and a glucose/buffer solution is placed as fuel in the recess 107a of the fixing plate 107, for electric power generation.

However, the biofuel cell shown in FIGS. 18A and 18B is disadvantageous in that when the fixing plates 106 and 107 are fastened together with the screws 108, pressure is easily concentrated in the screws 108, and thus pressure is not uniformly applied to the interfaces between the respective components of the biofuel cell, thereby easily causing variation in output. The biofuel cell is also disadvantageous in that a cell solution such as fuel easily leaks in a direction parallel to the interfaces between the respective components because of the low adhesion between the components, and the manufacturing process is complicated.

### SUMMARY

Accordingly, it is desirable to provide a fuel cell capable of suppressing variation in output when an enzyme is immobilized as a catalyst on at least one of positive and negative electrodes, preventing leakage of a cell solution such as fuel, and capable of being manufactured by a simple process. Also, it is desirable to provide a method for manufacturing the fuel cell and an electronic apparatus using the fuel cell.

A fuel cell according to a first embodiment includes positive and negative electrodes which are opposed to each other with a proton conductor provided therebetween, and an enzyme immobilized as a catalyst on at least one of the positive and negative electrodes. In the fuel cell, the positive electrode, the proton conductor, and the negative electrode are accommodated in a space formed between a positive electrode current collector having a structure permeable to an oxidizer and a negative electrode current collector having a structure permeable to fuel.

In the fuel cell, typically, the edge of one of the positive electrode current collector and the positive electrode current collector is caulked to the other of the positive electrode current collector and the positive electrode current collector through an insulating sealing member to form a space for accommodating the positive electrode, the proton conductor, and the negative electrode. However, the space is not limited to this, and the space may be formed by another processing method according to demand. The positive electrode current collector and the negative electrode current corrector are electrically insulated from each other through the insulating sealing member. As the insulating sealing member, typically, a gasket composed of an elastic material such as silicone rubber is used. However, the insulating sealing member is not limited to this. The planar shape of the positive electrode current collector and the negative electrode current corrector may be selected from, for example, a circular shape, an elliptic shape, a tetragonal shape, a hexagonal shape, and the like according to demand. The whole shape of the fuel cell is not particularly limited but may be selected according to demand, and the shape is typically a coin- or button-like shape. Typically, the positive electrode current collector has one or a plurality of oxidizer supply ports, and the negative electrode current collector has one or a plurality of fuel supply ports. However, the configuration is not limited to this, and, for example, a material permeable to the oxidizer may b used for the positive electrode current collector instead of the formation of the oxidizer supply ports. Similarly, a material permeable to fuel may be used for the negative electrode current collector instead of the formation of the fuel supply ports. The negative electrode current collector typically includes a fuel storage portion. The fuel storage portion may be provided integrally with or detachably from the negative electrode current collector. The fuel storage portion typically has a closing cover. In this case, the fuel may be injected in the fuel storage portion by removing the cover. The fuel may be injected from the side of the fuel storage portion without using the closing cover. When the fuel storage portion is provided detachably from the negative electrode current collector, for example, a fuel tank or fuel cartridge filled with fuel may be provided as the fuel storage portion. The fuel tank or fuel cartridge may be disposable but is preferably a type in which fuel can be charged from the viewpoint of effective utilization of resources. The used fuel tank or fuel cartridge may be exchanged for a fuel tank or fuel cartridge filled with fuel. Further, for example, the fuel storage portion may be formed in a closed vessel having a fuel supply portion and a fuel discharge port so that fuel is continuously supplied to the closed vessel from the outside through the supply port, thereby permitting continuous use of the fuel cell. Alternatively, the fuel cell may be used without using the fuel storage portion in a state in which the fuel cell floats on the fuel contained in an open fuel tank so that the negative electrode is on the lower side, and the positive electrode is on the upper side.

The enzyme immobilized on at least one of the positive and negative electrodes may be any one of various types and is selected according to demand. In addition to the enzyme, the electron mediator is preferably immobilized. Typically, the enzyme is immobilized on at least the negative electrode and preferably immobilized on both the positive and negative electrodes. For example, a monosaccharide such as glucose is used as fuel, the enzyme immobilized on the negative electrode contains an oxidase which accelerates oxidation of the monosaccharide and decomposes it, and generally further contains a coenzyme oxidase which returns an coenzyme reduced with an oxidase to an oxidized form. However, the enzyme is not limited to this. When the coenzyme is returned to the oxidized form by the action of the coenzyme oxidase, electrons are produced, and the electrons are supplied to the electrode from the coenzyme oxidase through the electron mediator. For example, NAD⁺-dependent glucose dehydrogenase (GHD) is used as the oxidase include, nicotinamide adenine dinucleotide (NAD⁺) is used as the coenzyme, and diaphorase is used as the coenzyme oxidase. However, the enzymes are not limited to these.

When a polysaccharide (in a broad sense, including all carbohydrates which yield at least two molecules of monosaccharide by hydrolysis, such as disaccharides, trisaccharides, tetrasaccharides, and the like) is used as the fuel, in addition to the oxidase, the coenzyme oxidase, the coenzyme, and the electron mediator, a catabolic enzyme which accelerates decomposition such as hydrolysis of a polysaccharide to produce a monosaccharide such as glucose is immobilized. Examples of polysaccharides include starch, amylose, amylopectin, glycogen, cellulose, maltose, sucrose, and lactose. Any one of these polysaccharides is composed of two or more monosaccharides and contains glucose as a monosaccharide of a bond unit. Amylose and amylopectin are components in starch which is composed of a mixture of amylose and amylopectin. When glucoamylase and glucose dehydrogenase are used as a catabolic enzyme for a polysaccharide and an oxidase for decomposing a monosaccharide, respectively, a polysaccharide which may be decomposed to glucose with glucoamylase, for example, any one of starch, amylose, amylopectin, glycogen, and maltose, may be contained in the fuel, for permitting power generation. Glucoamylase is a catabolic enzyme which hydrolyzes α-glucan such as starch to produce glucose, and glucose dehydrogenase is an oxidase which oxidizes β-D-glucose to D-glucono-δ-lactone. A catabolic enzyme which decomposes a polysaccharide may be immobilized on the negative electrode, and also a polysaccharide finally used as the fuel may be immobilized on the negative electrode.

When starch is used as fuel, starch may be gelatinized to form gelled solid fuel. In this case, the gelatinized starch may be brought into contact with the negative electrode on which ten enzyme is immobilized or may be immobilized on the negative electrode together with the enzyme. When such an electrode is used, the concentration of starch on the surface of the negative electrode is kept higher than that when a solution of starch is used, thereby increasing the rate of decomposition reaction with the enzyme. As a result, output is improved, and the fuel is easier to handle than the starch solution, thereby simplifying a fuel supply system. Further, the fuel cell may be turned over and is thus very advantageous in, for example, use for mobile devices.

As the electron mediator, basically, any material may be used, but a compound having a quinone skeleton, particularly a naphthoquinone skeleton, is preferably used. As the compound having a naphthoquinone skeleton, various naphthoquinone derivatives may be used. Examples of such derivatives include 2-amino-1,4-naphthoquinone (ANQ), 2-amino-3-methyl-1,4-naphthoquinone (AMNQ), 2-methyl-1,4-naphthoquinone (VK3), 2-amino-3-carboxy-1,4-naphthoquinone (ACNQ), and the like. As the compound having a quinone skeleton, for example, anthraquinone and its derivatives other than the compound having a naphthoquinone skeleton may be used. If required, besides the compound having a quinone skeleton, at least one other compound serving as the electron mediator may be contained. As a solvent used for immobilizing the compound having a quinone skeleton, particularly, the compound having a naphthoquinone skeleton, on the negative electrode, acetone is preferably used. When acetone is used as the solvent, the solubility of the compound having a quinone skeleton is increased, and thus the compound having a quinone skeleton is effectively immobilized on the negative electrode. The solvent may further contain at least one solvent other than acetone according to demand.

In an example, 2-methyl-1,4-naphthoquinone (VK3) as the electron mediator, reduced nicotinamide-adenine dinucleotide (NADH) as the coenzyme, glucose dehydrogenase as the oxidase coenzyme, and diaphorase as the coenzyme oxidase are immobilized on the negative electrode, preferably at an immobilization ratio of 1.0 (mol):0.33 to 1.0 (mol):(1.8 to 3.6)×10⁶ (U):(0.85 to 1.7)×10⁷ (U). U (unit) is an index showing an enzyme activity, i.e., a degree of reaction of 1 μmol of substrate per minute at a certain temperature and pH.

When the enzyme is immobilized on the positive electrode, the enzyme typically contains an oxygen-reductase. As the oxygen-reductase, for example, bilirubin oxidase, laccase, ascorbate oxidase, or the like may be used. In this case, as well as the enzyme, the electron mediator is preferably immobilized on the positive electrode. As the electron mediator, for example, potassium hexacyanoferrate, potassium ferricyanide, potassium octacyanotungstate, or the like may be used. The electron mediator is preferably immobilized at a sufficiently high concentration, for example, 0.64×10⁻⁶ mol/mm² or more in average.

As the immobilization material for immobilizing the enzyme, the coenzyme, the electron mediator, and the like on the negative electrode or the positive electrode, various materials may be used. Preferably, a polyion complex formed using polycation, such as poly-L-lysine (PLL), or its salt and polyanion, such as polyacrylic acid (e.g., sodium polyacrylate (PAAcNa)), or its salt may be used. The enzyme, the coenzyme, the electron mediator, and the like may be contained in the polyion complex.

On the other hand, the inventors have found the phenomenon that the output of the fuel cell may be significantly increased by immobilizing a phospholipid such as dimyristoyl phosphatidyl coline (DMPC) in addition to the enzyme and the electron mediator. Namely, the inventors have found that a phospholipid functions as an output increasing agent. As a result of various studies on a reason why output is increased by immobilizing a phospholipid, it has been concluded that separation and aggregation of the enzyme and the electron mediator are prevented by immobilization of the phospholipid, thereby uniformly mixing the enzyme and the electron mediator, while in a general fuel cell, sufficiently large output is not obtained for the reason that the enzyme and the electron mediator, which are immobilized on the negative electrode, are not uniformly mixed, causing separation and aggregation of the enzyme and the electron mediator. Further, as a result of research on the cause of uniform mixing of the enzyme and the electron mediator due to the addition of the phospholipid, there has been found the rare phenomenon that the diffusion coefficient of a reduced form of the electron mediator is significantly increased by adding the phospholipid. In other words, it has been found that the phospholipid functions as an electron mediator diffusion promoter. The effect of immobilization of the phospholipid is particularly significant when the electron mediator is the compound having a quinone skeleton. The same effect is obtained even by using a phospholipid derivative or a polymer of the phospholipid or its derivative instead of the phospholipid. Most generally speaking, the output increasing agent is an agent for improving the reaction rate on an electrode on which the enzyme and the electron mediator have been immobilized, increasing output. Most generally speaking, the electron mediator diffusion promoter is an agent for increasing the diffusion coefficient of the electron mediator within an electrode on which the enzyme and the electron mediator have been immobilized or maintaining or increasing the concentration of the electron mediator near the electrode.

As a material for the positive electrode and the negative electrode, a general material such as a carbon-based material may be used, or a porous conductive material including a skeleton composed of a porous material and a carbon-based material as a main component which coats at least a portion of the surface of the skeleton may be used. The porous conductive material may be obtained by coating at least a portion of the surface of a skeleton, which is composed of a porous material, with a material which contains a carbon-based material as a main component. The porous material constituting the skeleton of the porous conductive material may be basically any material regardless of the presence of conductivity as long as the skeleton is stably maintained even with high porosity. As the porous material, a material having high porosity and high conductivity is preferably used. Examples of such a material having high porosity and high conductivity include metal materials (metals or alloys) and carbon-based materials with a strengthened skeleton (improved brittleness). When a metal material is used as the porous material, there are various possible alternatives because condition stability of the metal material varies with the operation environment conditions, such as the solution pH and potential. For example, a foamed metal or foamed alloy, such as nickel, copper, silver, gold, nickel-chromium alloy, stainless steel, or the like, is one of easily available materials. Besides the metal materials and carbon-based materials, resin materials (e.g., sponge-like) may be used. The porosity and pore size (minimum pore size) of the porous material are determined according to the porosity and pore size desired for the porous conductive material in consideration of the thickness of the material mainly composed of the carbon-based material and used for coating the surface of the skeleton composed of the porous material. The pore size of the porous material is generally 10 nm to 1 mm and typically 10 nm to 600 μm. On the other hand, the material used for coating the surface of the skeleton is desired to have conductivity and stability at an estimated operation potential. As such a material, a material composed of a carbon-based material as a main component is used. The carbon-based material generally has a wide potential window and often has chemical stability. Examples of the material composed of the carbon-based material as a main component include materials composed of only a carbon-based material and materials composed of a carbon-based material as a main component and a small amount of sub-material selected according to the characteristics required for the porous conductive material. Examples of the latter materials include a material including a carbon-based material to which a high-conductivity material such as a metal is added for improving electric conductivity, and a material including a carbon-based material to which a polytetrafluoroethylene material is added to impart surface water repellency other than conductivity. Although there are various types of carbon-based materials, any carbon-based material may be used, and the carbon-based material may be elemental carbon or may contain an element other than carbon. In particular, the carbon-based material is preferably a fine powder carbon material having high conductivity and a high surface area. Examples of the carbon-based material include KB (Ketjenblack) imparted with high conductivity, and functional carbon materials such as carbon nanotubes, fullerene, and the like. As a method for coating with the material composed of the carbon-based material as a main component, any coating method may be used as long as the surface of the skeleton composed of the porous material can be coated using an appropriate binder according to demand. The pore size of the porous conductive material is selected so that the solution containing the substrate easily passes through the pores, and is generally 9 nm to 1 mm, more generally 1 μm to 1 mm, and most generally 1 to 600 μm. In a state in which at least a portion of the surface of the skeleton composed of the porous material is coated with the material composed of the carbon-based material as a main component, preferably, all pores communicate with one another or clogging doe not occur due to the material composed of the carbon-based material as a main component.

A pellet electrode may be used as each of the positive electrode and the negative electrode. The pellet electrode may be formed as follows: a carbon-based material (particularly preferably a fine power carbon material having high conductivity and high surface area), specifically KB (Ketjenblack) imparted with high conductivity or a functional carbon material such as carbon nanotubes, fullerene, or the like, a binder, e.g., poly(vinylidene fluoride), according to demand, the enzyme powder (or the enzyme solution), the coenzyme powder (or the coenzyme solution), the electron mediator powder (or the electron mediator solution), and the immobilization polymer powder (or the polymer solution), are mixed in an agate mortar, appropriately dried, and then pressed into a predetermined shape. The thickness (electrode thickness) of the pellet electrode is determined according to demand, but is, for example, about 50 μm. For example, when the coin-shaped fuel cell is manufactured, the pellet electrode may be formed by pressing the above-described materials for forming the pellet electrode into a circular shape using a tablet machine. The diameter of the circular shape is, for example, 15 mm, but is not limited to this and determined according to demand. When the pellet electrode is formed, the electrode thickness is adjusted to a desired value by controlling the amount of carbon contained in the materials for forming the pellet electrode and the pressing pressure. When the positive or negative electrode is inserted into a coin-like cell can, electric contact between the positive and negative electrodes are preferably achieved by, for example, inserting a metal mesh spacer between the positive or negative electrode and the electrode case.

Instead of the above-described method for forming the pellet electrode, a mixed solution (an aqueous or organic solvent mixed solution) of the carbon-based material, the binder according to demand, and the enzyme immobilization components (the enzyme, coenzyme, electron mediator, polymer, and the like) may be appropriately applied on a current collector and dried, and the whole may be pressed and then cut into a desired electrode size.

When an electrolyte containing a buffer material (buffer solution) is used as the proton conductor, in order achieve a sufficient buffer ability in a high-output operation and sufficiently exhibit the original ability of the enzyme used, the concentration of the buffer material contained in the electrolyte is effectively 0.2 M to 2.5 M, preferably 0.2 M to 2 M, more preferably 0.4 M to 2 M, and still more preferably 0.8 M to 1.2 M. Any buffer material may be used as long as pKₐ is 6 to 9. Examples of such a buffer material include dihydrogen phosphate ion (H₂PO₄⁻), 2-amino-2-hydroxymethyl-1,3-propanediol (abbreviated as “tris”), 2-(N-morpholino)ethanesulfonic acid (MES), cacodylic acid, carbonic acid (H₂CO₃), hydrogen citrate ion, N-(2-acetamido)iminodiacetic acid (ADA), piperazine-N,N′-bis(2-ethanesulfonic acid) (PIPES), N-(2-acetamido)-2-aminoethanesulfonic acid (ACES), 3-(N-morpholino)propanesulfonic acid (MOPS), N-2-hydroxyethylpiperazine-N′-2-ethanesulfonic acid (HEPES), N-2-hydroxyethylpiperazine-N′-3-propanesulfonic acid (HEPPS), N-[tris(hydroxymethyl)methyl]glycine (abbreviated as “tricine”), glycylglycine, and N,N-bis(2-hydroxyethyl)glycine (abbreviated as “bicine”). Examples of a material producing dihydrogen phosphate ion (H₂PO₄⁻) include sodium dihydrogen phosphate (NaH₂PO₄) and potassium dihydrogen phosphate (KH₂PO₄). A compound containing an imidazole ring is also preferred as the buffer material. Examples of the compound containing an imidazole ring include imidazole, triazole, pyridine derivatives, bipyridine derivatives, and imidazole derivatives, such as histidine, 1-methylimidazole, 2-methylimidazole, 4-methylimidazole, 2-ethylimidazole, ethyl imidazole-2-carboxylate, imidazole-2-carboxyaldehyde, imidazole-4-carboxylic acid, imidazole-4,5-dicarboxylic acid, imidazol-1-yl-acetic acid, 2-acetylbenzimidazole, 1-acetylimidazole, N-acetylimidazole, 2-aminobenzimidazole, N-(3-aminopropyl)imidazole, 5-amino-2-(trifluoromethyl)benzimidazole, 4-azabenzimidazole, 4-aza-2-mercaptobenzimidazole, benzimidazole, 1-benzylimidazole, and 1-butylimidazole. The pH of the electrolyte containing the buffer material is preferably near 7 but is generally 1 to 14.

The fuel cell may be used for all applications requiring electric power regardless of size. For example, the fuel cell may be used for electronic apparatuses, movable bodies (an automobile, a bicycle, an aircraft, a rocket, and a spacecraft), power plants, construction machines, machine tools, power generating systems, and co-generation systems. The output, size, shape, and fuel type are determined according to applications.

According to a second embodiment, a method for manufacturing a fuel cell including positive and negative electrodes which are opposed to each other with a proton conductor provided therebetween, and an enzyme immobilized as a catalyst on at least one of the positive and negative electrodes includes the steps of sandwiching the positive electrode, the proton conductor, and the negative electrode between a positive electrode current collector having a structure permeable to an oxidizer and a negative electrode current collector having a structure permeable to fuel, and caulking the edge of one of the negative electrode current collector and the positive electrode current collector to the other of the positive electrode current collector and the negative electrode current collector through an insulating sealing member.

In the method for manufacturing the fuel cell, typically, at least one of the positive electrode current collector and the negative electrode current collector has a cylindrical shape with an open end. Specifically, for example, both the positive electrode current collector and the negative electrode current collector have a cylindrical shape with an open end. The positive electrode, the proton conductor, and the negative electrode are stacked in order on the bottom in the cylindrical positive electrode current collector. Then, the bottom in the cylindrical negative electrode current collector with an open end is brought into contact with the negative electrode, and pressure is applied to the positive and negative electrode current collectors with the positive electrode, the proton conductor, and the negative electrode provided therebetween so that the edge of the positive electrode current collector is caulked to the negative electrode current collector through the sealing member. Consequently, the positive electrode, the proton conductor, and the negative electrode are accommodated in the space between the positive and negative electrode current collectors.

With respect to the other characteristics, the description in the first embodiment applies to the second embodiment as long as properties are not adversely affected.

A fuel cell according to a third embodiment includes positive and negative electrodes which are opposed to each other with a proton conductor provided therebetween, and an enzyme immobilized as a catalyst on at least one of the positive and negative electrodes. In the fuel cell, the negative electrode, the proton conductor, the positive electrode, and a positive electrode current collector having a structure permeable to an oxidizer are provided in order around a predetermined central axis, and a negative electrode current collector having a structure permeable to fuel is provided to be electrically connected to the negative electrode.

In the fuel cell, the negative electrode may have a cylindrical or columnar shape having a circular, elliptic, or polygonal sectional shape. When the negative electrode has a cylindrical shape, the negative electrode current collector may be provided on the inner periphery of the negative electrode, provided between the negative electrode and the proton conductor, provided on at least one end of the negative electrode, or provided at two positions or more of these. In addition, the negative electrode may be configured to hold the fuel. For example, the negative electrode may be made of a porous material so as to also serve as a fuel holding portion. Alternatively, a columnar fuel holding portion may be provided on a predetermined central axis. For example, when the negative electrode current collector is provided on the inner periphery of the negative electrode, the fuel holding portion may include the space around the negative electrode current collector or a vessel such as a fuel tank or a fuel cartridge provided in the space separately from the negative electrode current collector. The vessel may be detachable or fixed. The fuel holding portion has a columnar shape, an elliptic cylindrical shape, or a polygonal cylindrical shape such as a quadratic or hexagonal cylindrical shape, but the shape is not limited to this. The proton conductor may be formed in a bag-like vessel so as to wrap all the negative electrode and the negative electrode current collector. In this case, when the fuel holding portion is fully charged with the fuel, the fuel comes in contact with the whole negative electrode. In the vessel, at least a portion sandwiched between the positive electrode and the negative electrode may be made of the proton conductor, and the other portion may be made of a material other than the proton conductor. Further, the fuel vessel may be formed in a closed vessel having a fuel supply port and a fuel discharge port so that fuel is continuously supplied to the closed vessel from the outside through the supply port, thereby permitting continuous use of the fuel cell. The negative electrode preferably has a high void ratio, for example a void ratio of 60% or more, in order to permit the negative electrode to store sufficient fuel therein.

With respect to the other characteristics, the description in the first embodiment applies to the third embodiment as long as properties are not adversely affected.

According to a fourth embodiment, an electronic apparatus includes one or a plurality of fuel cells, wherein at least one fuel cell includes positive and negative electrodes which are opposed to each other with a proton conductor provided therebetween, and an enzyme immobilized as a catalyst on at least one of the positive and negative electrodes. In the fuel cell, the negative electrode, the proton conductor, and the positive electrode are accommodated in a space formed between a positive electrode current collector having a structure permeable to an oxidizer and a negative electrode current collector having a structure permeable to fuel.

According to a fifth embodiment, an electronic apparatus includes one or a plurality of fuel cells, wherein at least one fuel cell includes positive and negative electrodes which are opposed to each other with a proton conductor provided therebetween, and an enzyme immobilized as a catalyst on at least one of the positive and negative electrodes. In the fuel cell, the negative electrode, the proton conductor, the positive electrode, and a positive electrode current collector having a structure permeable to an oxidizer are provided in order around a predetermined central axis, and a negative electrode current collector having a structure permeable to fuel is provided to be electrically connected to the negative electrode.

The electronic apparatus may be basically any type, e.g., a portable type or a stationary type. Examples of the electronic apparatus include cellular phones, mobile devices, robots, personal computers, game equipment, automobile-installed equipment, home electric appliances, and industrial products.

Apart from the above description, the description in the first to third embodiments applies to the fourth and fifth embodiments as long as properties are not adversely affected.

As described above, pressure is applied to the positive and negative electrode current collectors with the positive electrode, the proton conductor, and the negative electrode provided therebetween so that the positive electrode current collector, the positive electrode, the proton conductor, the negative electrode, and the negative electrode current collector are brought into tight contact. In this state, the edge of one of the positive electrode current collector and the negative electrode current collector is caulked to the other electrode current collector by, for example, pressing. Consequently, the positive electrode, the proton conductor, and the negative electrode are accommodated in the space between the positive and negative electrode current collectors. In this case, pressure is uniformly applied to the interfaces between the positive electrode current collector, the positive electrode, the proton conductor, the negative electrode, and the negative electrode current collector, thereby preventing variation in output. In addition, the positive electrode current collector, the positive electrode, the proton conductor, the negative electrode, and the negative electrode current collector are brought into tight contact, thereby preventing leakage of the cell solution such as fuel from the interfaces between the positive electrode current collector, the positive electrode, the proton conductor, the negative electrode, and the negative electrode current collector. Further, the fuel cell is manufactured only by pressing the positive electrode current collector and the negative electrode current collector with the positive electrode, the proton conductor, and the negative electrode provided therebetween, thereby simplifying the manufacturing process.

According to an embodiment, it may be possible to manufacture a fuel cell capable of suppressing variation in output when an enzyme is immobilized as a catalyst on at least one of positive and negative electrodes, preventing leakage of a cell solution such as fuel, and capable of being manufactured by a simple process. Also, it may be possible to realize a high-performance electronic apparatus using the excellent fuel cell.

Additional features and advantages are described herein, and will be apparent from the following Detailed Description and the figures.

### BRIEF DESCRIPTION OF THE FIGURES

FIGS. 1A, 1B, and 1C are a top view, a sectional view, and a back view, respectively, showing a biofuel cell according to a first embodiment;

FIG. 2 is an exploded perspective view showing the biofuel cell according to the first embodiment;

FIGS. 3A, 3B, 3C, and 3D are schematic drawings illustrating a method for manufacturing the biofuel cell according to the first embodiment;

FIGS. 4A, 4B, and 4C are schematic drawings showing output characteristics of the biofuel cell according to the first embodiment;

FIG. 5 is a schematic diagram showing changes with time in output of the biofuel cell according to the first embodiment;

FIGS. 6A, 6B, and 6C are schematic drawings showing output characteristics of a biofuel cell according to a second embodiment;

FIG. 7 is a schematic diagram showing changes with time in output of the biofuel cell according to the second embodiment;

FIG. 8 is a schematic drawing illustrating a first example of a method of using the biofuel cell according to the first embodiment;

FIG. 9 is a schematic drawing illustrating a second example of a method of using the biofuel cell according to the first embodiment;

FIG. 10 is a schematic drawing illustrating a third example of a method of using the biofuel cell according to the first embodiment;

FIG. 11 is a schematic drawing showing a method of using the biofuel cell according to the second embodiment;

FIGS. 12A and 12B are a front view and a longitudinal sectional view, respectively, showing a biofuel cell according to a third embodiment;

FIG. 13 is an exploded perspective view showing the biofuel cell according to the third embodiment;

FIGS. 14A, 14B, and 14C are schematic diagrams showing output characteristics of a biofuel cell Example 3;

FIG. 15 is a schematic diagram showing changes with time in output of the biofuel cell of Example 3;

FIGS. 16A and 16B are a schematic drawing and a sectional view, respectively, illustrating a structure of a porous conductive material used as an electrode material in a biofuel cell according to a fourth embodiment;

FIGS. 17A and 17B are schematic drawings illustrating a method for manufacturing a porous conductive material used as an electrode material in a biofuel cell according to the fourth embodiment; and

FIGS. 18A and 18B are a sectional view and a schematic drawing, respectively, showing a biofuel cell of related art.

### DETAILED DESCRIPTION

Embodiments will be described with reference to the drawings. In all drawings of the embodiments, the same or corresponding portions are denoted by the same reference numeral.

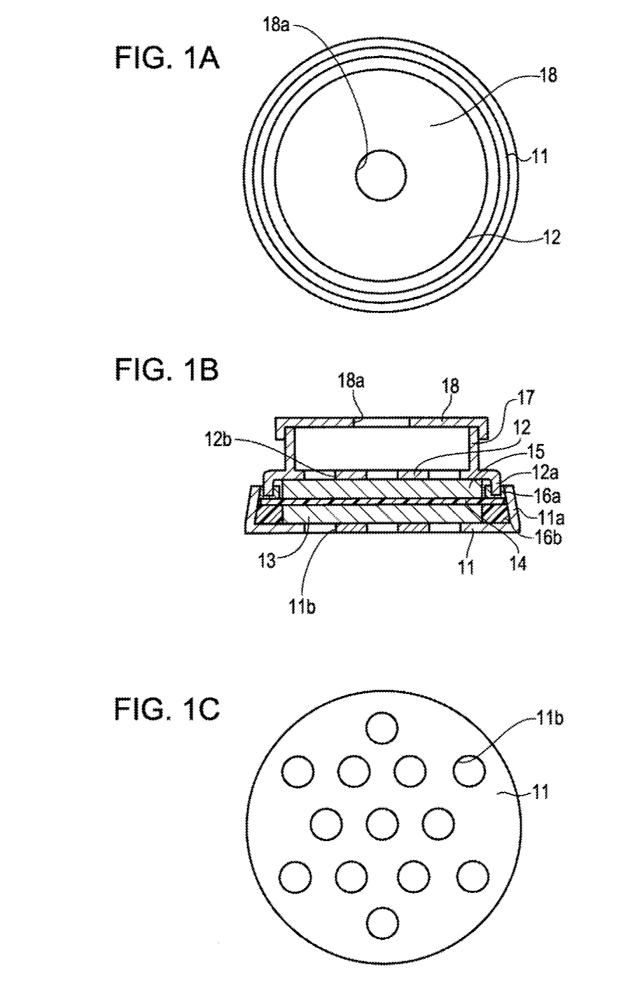

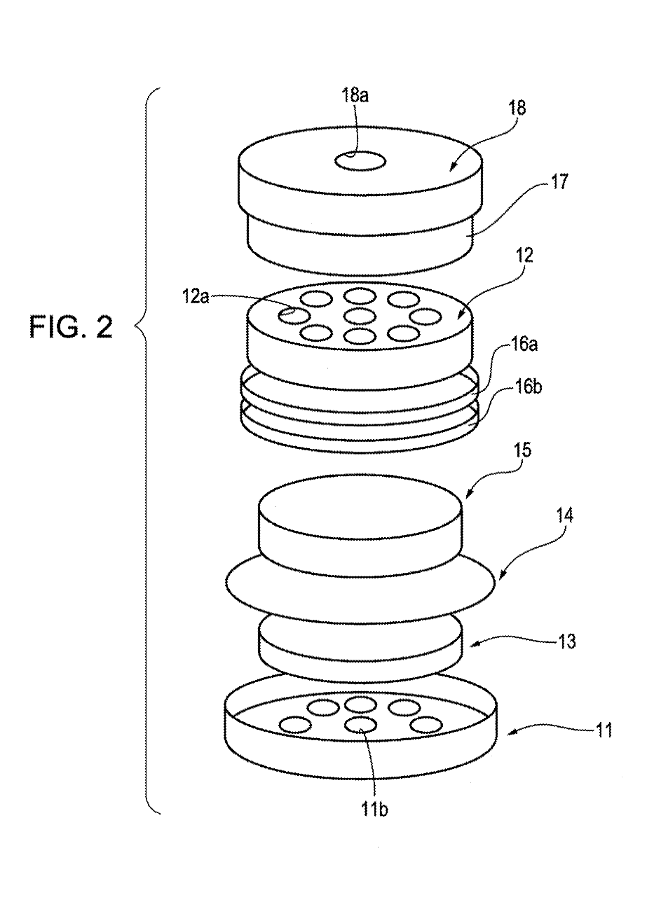

FIGS. 1A, 1B, 1C, and 2 show a biofuel cell according to a first embodiment. FIGS. 1A, 1B, and 1C are a top view, a sectional view, and a back view, respectively, showing the biofuel cell, and FIG. 2 is an exploded perspective view showing components of the biofuel cell.

As shown in FIGS. 1A, 1B, 1C, and 2, the biofuel cell includes a positive electrode 13, a proton conductor 14, and a negative electrode 15 which are accommodated in a space formed by a positive electrode current collector 11 and a negative electrode current collector 12 so as to be vertically sandwiched between the positive electrode current collector 11 and the negative electrode current collector 12. The positive electrode current collector 11, the negative electrode current collector 12, the positive electrode 13, the proton conductor 14, and the negative electrode 15 are brought into tight contact between adjacent ones. In this case, the positive electrode current collector 11, the positive electrode 13, the negative electrode current collector 12, the proton conductor 14, and the negative electrode 15 have a circular planar shape. Also, the whole biofuel cell has a circular planar shape.

The positive electrode current collector 11 is adapted for collecting a current produced in the positive electrode 13, and the current is taken out from the positive electrode current collector 11. The negative electrode current collector 12 is adapted for collecting a current produced in the negative electrode 15. The positive electrode current collector 11 and the negative electrode current collector 12 are generally made of a metal or an alloy, but the material is not limited to this. The positive electrode current collector 11 is flat and has a substantially cylindrical shape. Also, the negative electrode current collector 12 is flat and has a substantially cylindrical shape. The outer peripheral edge 11a of the positive electrode current collector 11 is caulked to the outer periphery 12a of the negative electrode current collector 12 through a ring-shaped gasket 16a made of an insulating material, such as silicone rubber, and a ring-shaped hydrophobic resin 16b made of, for example, polytetrafluoroethylene (PTFE), thereby forming a space in which the positive electrode 13, the proton conductor 14, and the negative electrode 15 are accommodated. The hydrophobic resin 16b is provided in the space surrounded by the positive electrode 131, the positive electrode current collector 11, and the gasket 16a so as to be in tight contact with the positive electrode 13, the positive electrode current collector 11, and the gasket 16a. The hydrophobic resin 16b effectively suppresses excessive permeation of fuel into the positive electrode 13. The end of the proton conductor 14 extends outward from the positive electrode 13 and the negative electrode 15 so as to be held between the gasket 16a and the hydrophobic resin 16b. The positive electrode current collector 11 has a plurality of oxidizer supply ports 11b provided over the entire surface of the bottom so that the positive electrode 13 is exposed in the oxidizer supply ports 11b. FIGS. 1C and 2 show thirteen circular oxidizer supply ports 11b, but this is an only example, and the number, the shape, the size, and the arrangement of the oxidizer supply ports 11b may be appropriately selected. The negative electrode current collector 12 also has a plurality of fuel supply ports 12b provided over the entire surface of the top so that the negative electrode 15 is exposed in the fuel supply ports 12b. FIG. 2 shows seven circular fuel supply ports 12b, but this is an only example, and the number, the shape, the size, and the arrangement of the fuel supply ports 12b may be appropriately selected.

The negative electrode current collector 12 has a cylindrical fuel tank 17 provided on the side opposite to the negative electrode 15. The fuel tank 17 is formed integrally with the negative electrode current collector 12. The fuel tank 17 contains fuel to be used (not shown), for example, a glucose solution or a glucose solution containing an electrolyte. In addition, a cylindrical cover 18 is detachably provided on the fuel tank 17. The cover 18 is inserted into or screwed on the fuel tank 17. Further, a circular fuel supply port 18a is formed at the center of the cover 18. The fuel supply port 18a is sealed by, for example, attaching a seal (not shown).

The negative electrode 15 is composed of porous carbon and an enzyme involved in decomposition of the fuel and related coenzyme and coenzyme oxidase are immobilized on the surface of the electrode by an immobilization material composed of, for example, a polymer. In addition to the enzyme, the coenzyme, and the coenzyme oxidase, an electron mediator is preferably immobilized on the negative electrode 15, for receiving, from the coenzyme oxidase, electrons produced in association with oxidation of the coenzyme and for supplying the electrons to the electrode. For example, when a glucose solution is used as fuel, the negative electrode 15 includes an enzyme involved in decomposition of glucose, a coenzyme (e.g., NAD⁺, NADP⁺, or the like) producing a reduced form in association with an oxidation reaction in the glucose decomposition process, a coenzyme oxidase (e.g., diaphorase) which oxidizes the reduced form of the coenzyme (e.g., NADH, NADPH, or the like), and an electron mediator which receives, from the coenzyme oxidase, electrons produced in association with oxidation of the coenzyme and which supplies the electrons to the electrode, the enzyme, the coenzyme, the coenzyme oxidase, and the electron mediator being immobilized on the electrode by an immobilization material composed of, for example, a polymer.

As the enzyme involved in decomposition of glucose, for example, glucose dehydrogenase (GDH) may be used. When this oxidase is present, for example, β-D-glucose is oxidized into D-glucono-δ-lactone.

Further, the D-glucono-δ-lactone is decomposed into 2-keto-6-phospho-D-gluconate by the presence of two enzymes, i.e., gluconokinase and phosphogluconate dehydrogenase (PhGDH). In other words, the D-glucono-δ-lactone is converted into D-gluconate by hydrolysis, and the D-gluconate is phosphorylated to 6-phospho-D-gluconate by hydrolysis of adenosine triphosphate (ATP) into adenosine diphosphate (ADP) and phosphoric acid in the presence of gluconokinase. The 6-phospho-D-gluconate is oxidized into 2-keto-6-phospho-D-gluconate by the action of the oxidase PhGDH.

The glucose may be decomposed into CO₂ by utilizing glucose metabolism other than the above-described decomposition process. The decomposition process utilizing glucose metabolism is roughly divided into glucose decomposition by a glycolytic system, production of pyruvic acid, and a TCA cycle, which are widespread reaction systems.

The oxidation reaction in the decomposition process of a monosaccharide proceeds in association with a reduction reaction of a coenzyme. The coenzyme is substantially determined according to the enzyme acting. In the case of GDH, NAD⁺ is used as the coenzyme. Namely, when β-D-glucose is oxidized into D-glucono-δ-lactone by the action of GDH, NAD⁺ is reduced into NADH, producing protons (H⁺).

The produced NADH is immediately oxidized into NAD⁺ in the presence of diaphorase (DI), producing two electrons and H⁺. Therefore, two electrons and two H⁺ are produced in one step of oxidation reaction per molecule of glucose, and four electrons and four H⁺ in total are produced in two steps of oxidation reaction.

The electrons produced in the above-mentioned process are transferred to the negative electrode 15 from diaphorase through the electron mediator, and H⁺ are transferred to the positive electrode 13 through the proton conductor 14.

The electron mediator receives and transfers electrons from and to the negative electrode 15, and the output voltage of the fuel cell depends on the oxidation-reduction potential of the electron mediator. In other words, in order to obtain a higher output voltage, the electron mediator with a more negative potential is preferably selected for the negative electrode 15. However, it may be necessary to consider the reaction affinity of the electron mediator for the enzyme, the rate of electron exchange to the electrode, the structural stability to inhibitors (light, oxygen, and the like), and the like. From this viewpoint, as the electron mediator used for the negative electrode 15, ACNQ or VK3 is preferably used. Examples of other usable electron mediators include compounds having a quinone skeleton, metal complexes of osmium (Os), ruthenium (Ru), iron (Fe), and cobalt (Co), viologen compounds such as benzylviologen, compounds having a nicotinamide structure, compounds having a riboflavin structure, compounds having a nucleotide phosphate structure, and the like.

Examples of the immobilization material used for immobilizing the enzyme, the coenzyme, and the electron mediator on the negative electrode 15 include a combination of glutaraldehyde (GA) and poly-L-lysine (PLL) and a combination of sodium polyacrylate (PAAcNa) and poly-L-lysine (PLL). These may be used alone or another polymer may be further used. When a combination of glutaraldehyde and poly-L-lysine is used as the immobilization material, the enzyme immobilizing ability possessed by the material is greatly improved, thereby achieving the excellent enzyme immobilizing ability of the immobilizing material as a whole. In this case, the optimum composition ratio between glutaraldehyde and poly-L-lysine varies depending on the enzyme to be immobilized and the substrate of the enzyme, but may be generally a desired value. For example, when an aqueous solution of glutaraldehyde (0.125%) and an aqueous solution of poly-L-lysine (1%) are used, the ratio may be 1:1, 1:2, or 2:1.

The positive electrode 13 is composed of, for example, a carbon powder, fibrous carbon, or porous carbon, which carries a catalyst, or catalyst particles not carried on carbon. Examples of the catalyst include platinum (Pt) fine particles, and fine particles of alloys of platinum and a transition metal such as iron (Fe), nickel (Ni), cobalt (Co), or ruthenium (Ru) or oxides. The positive electrode 13 is formed in a structure in which a catalyst layer composed of a catalyst or a carbon powder containing a catalyst and a gas diffusion layer composed of porous carbon are laminated in order from the proton conductor side. The positive electrode 13 is not limited to this structure, and an oxygen reductase, e.g., bilirubin oxidase, may be immobilized as the catalyst. In this case, the oxygen reductase is preferably used in combination with the electron mediator which receives and transfers electrons from and to the electrode. On the positive electrode 13, water is produced by, for example, reduction of air oxygen, with H⁺ transferred through the proton conductor 14 and electrons supplied from the negative electrode 15 in the presence of the catalyst.

The proton conductor 14 is adapted for transferring H⁺ produced on the negative electrode 15 to the positive electrode 13 and is composed of a material which has no electron conductivity and is capable of transferring H⁺. Examples of a material of the proton conductor 14 include, but are not limited to, cellophane, gelatin, ion exchange resins containing fluorine-containing carbon sulfonic acid groups (e.g., Nafion (trade name, US DuPont)), and the like.

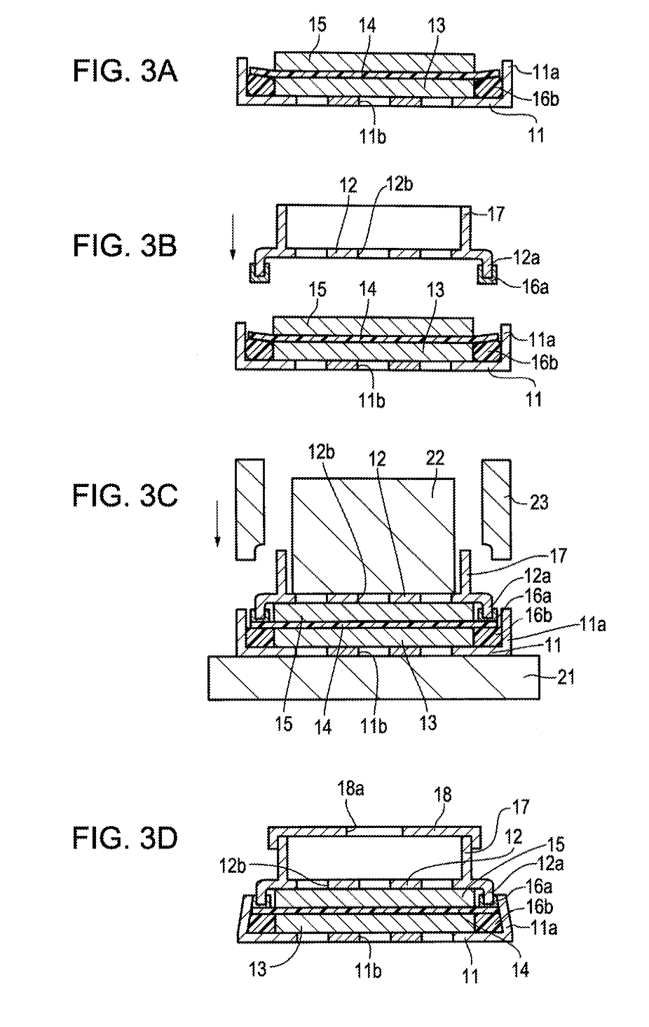

Next, an example of the method of manufacturing the biofuel cell is described. FIGS. 3A to 3D show the manufacturing method.

As shown in FIG. 3A, first, the positive electrode current collector 11 having a cylindrical shape with an open end is prepared. The positive electrode current collector 11 has a plurality of oxidizer supply ports 11b formed over the entire surface of the bottom thereof. Then, the ring-shaped hydrophobic resin 16b is placed on the outer periphery of the inner bottom of the positive electrode current collector 11, and the positive electrode 13, the proton conductor 14, and the negative electrode 15 are stacked in order on the central portion of the bottom.

On the other hand, as shown in FIG. 3B, the negative electrode current collector 12 having a cylindrical shape with an open end and the fuel tank 17 formed integrally with the negative electrode current collector 15 are prepared. The negative electrode current collector 12 has a plurality of fuel supply ports 12b formed over the entire surface thereof. Then, the gasket 16a having a U-shaped sectional form is provided on the peripheral edge of the negative electrode current collector 12. The negative electrode current collector 12 is placed on the negative electrode 15 so that the open end is on the lower side, and the positive electrode 13, the proton conductor 14, and the negative electrode 15 are sandwiched between the positive and negative electrode current collectors 11 and 12.

Next, as shown in FIG. 3C, the positive and negative electrode current collectors 11 and 12 with the positive electrode 13, the proton conductor 14, and the negative electrode 15 sandwiched therebetween are placed on a base 21 of a caulking machine, and the negative electrode current collector 12 is pressed with a pressing member 22 to bring the positive electrode current collector 11, the positive electrode 13, the proton conductor 14, the negative electrode 15, and the negative electrode current collector 12 into tight contact with adjacent ones. In this state, a caulking tool 23 is lowered to caulk the edge of the peripheral portion 11b of the positive electrode current collector 11 to the peripheral portion 12b of the negative electrode current collector 12 through the gasket 16a and the hydrophobic resin 16b. The caulking is performed so as to gradually crush the gasket 16a, thereby forming no space between the positive electrode current collector 11 and the gasket 16a and between the negative electrode current collector 12 and the gasket 16a. In this case, the hydrophobic resin 16b is gradually compressed so as to be brought into tight contact with the positive electrode 13, the positive electrode current collector 11, and the gasket 16a. Therefore, the positive and negative electrode current collectors 11 and 12 are electrically insulated from each other through the gasket 16a, forming a space therebetween in which the positive electrode 13, the proton conductor 14 and the negative electrode 15 are accommodated. Then, the caulking tool 23 is moved upward.

As a result, as shown in FIG. 3D, the biofuel cell is manufactured, in which the positive electrode 13, the proton conductor 14, and the negative electrode 15 are accommodated in the space formed by the positive and negative electrode current collectors 11 and 12.

Next, the cover 18 is attached to the fuel tank 17, and the fuel and the electrolyte are injected through the fuel supply port 18a of the cover 18. Then, a sealing seal is attached to the fuel supply port 18a to close it. However, the fuel and electrolyte may be injected into the fuel tank 17 in the step shown in FIG. 3B.

In the biofuel cell, for example, when a glucose solution is used as the fuel to be charged in the fuel tank 17, on the negative electrode 15, the glucose supplied is decomposed with the enzyme to produce electrons and H⁺. On the positive electrode 13, water is produced from H⁺ transferred from the negative electrode 15 through the proton conductor 14, the electrons transferred from the negative electrode 15 through an external circuit, and oxygen, for example, air oxygen. As a result, an output voltage is produced between the positive and negative electrode current collectors 11 and 12.

### EXAMPLE 1

A biofuel cell was assembled and the output characteristics thereof were evaluated. The biofuel cell had a diameter of 16 mm and a thickness of 1.9 mm, and the positive and negative electrodes 13 and 15 had a diameter of 15 mm (electrode area, 177 mm²). The positive electrode current collector 11 and the negative electrode current collector 12 were made of stainless steel. The positive electrode current collector 11 had a total of seven oxidizer supply ports 11b formed at the respective apexes of a hexagon and at the center thereof. Similarly, the negative electrode current collector 12 had a total of seven fuel supply ports 12b formed at the respective apexes of a hexagon and at the center thereof.

However, the shape, number, size, and arrangement of the oxidizer supply ports 11b and the fuel supply ports 12b are not limited to the above and are preferably optimized so as to permit efficient material transfer, i.e., supply of fuel and air (oxygen). In particular, with respect to the fuel supply ports 12b, a circular fuel supply port 12b having a diameter of, for example, about 3 mm is preferably formed at the center of the negative electrode current collector 12 in order to improve fuel permeation into the negative electrode 15.

As the negative electrode 15, an enzyme/electron mediator immobilized electrode formed as described below was used.

First, various solutions were prepared as follows: A 100 mM sodium dihydrogen phosphate (NaH₂PO₄) buffer solution (I. S.=0.3, pH=7.0) was used as a buffer solution.

Diaphorase (DI) (EC1. 6. 99.—manufactured by Unitika, B1D111) was weighed in an amount of 5 to 10 mg and dissolved in 1.0 ml to prepare a DI enzyme buffer solution (1).

Glucose dehydrogenase (GDH) (NAD-dependent type, EC1. 1. 1. 47, manufactured by Toyobo, GLD-311) was weighed in an amount of 10 to 15 mg and dissolved in 1.0 ml of a buffer solution to prepare a GDH enzyme buffer solution (2).

The buffer solution for dissolving the enzymes is preferably refrigerated up to a time immediately before use, and the enzyme buffer solutions are preferably refrigerated as much as possible.

NADH (manufactured by Sigma-Aldrich, N-8129) was weighed in an amount of 30.0 to 60.0 mg and dissolved in 0.1 ml of a buffer solution to prepare a NADH buffer solution (3).

An appropriate amount of poly-L-lysine hydrogen bromide (PLL) (manufactured by Wako, 164-16961) was weighed and dissolved in ion-exchanged water so that the concentration was 1 to 2 wt % to prepare a PLL aqueous solution (4).

2-Amino-1,4-naphthoquinone (ANQ) (synthetic product) was weighed in an amount of 10 to 50 mg and dissolved in 1 ml of acetone to prepare an ANQ acetone solution (5).

An appropriate amount of sodium polyacrylate (PAAcNa) (manufactured by Aldrich, 041-00595) was weighed and dissolved in ion-exchanged water so that the concentration was 0.01 to 0.1 wt % to prepare a PAAcNa aqueous solution (6).

The solutions prepared as described above were applied in the order of (5), (1), (3), (2), (4), and (6) on porous carbon (manufactured by Tokai Carbon, diameter 15 mm, thickness 2 mm) using a microsyringe in the amounts described below, and then appropriately dried to form an enzyme/electron mediator immobilized electrode.

DI enzyme buffer solution (1): 10 μl

GDH enzyme buffer solution (2): 10 μl

NADH buffer solution (3): 10 μl

PLL aqueous solution (4): 10 μl

ANQ acetone solution (5): 7 μl

PAAcNa aqueous solution (6): 4 μl

As the positive electrode 13, an enzyme/electron mediator-immobilized electrode formed as described below was used. First, commercial carbon felt (manufactured by TORAY, B0050) was used as porous carbon and cut into a circle having a diameter of 15 mm. Next, 80 μl of hexacyanoferrate ion (100 mM), 80 μl of poly-L-lysine (1 wt %), and 80 μl (50 mg/ml) of BOD solution were penetrated in order into the carbon felt, and then dried to form an enzyme/electron mediator immobilized electrode. Two enzyme/electron mediator immobilized electrodes produced as described above were stacked to form the positive electrode 13.

Then, cellophane was sandwiched as the proton conductor 14 between the positive electrode 13 and the negative electrode 15 formed as described above, and a biofuel cell was assembled by the above-described method. As the fuel and electrolyte, a 400 mM glucose solution containing 2 M of imidazole buffer solution (pH=7) was used, and the solution was injected into the fuel tank 17 through the fuel supply port 18a of the cover 18.

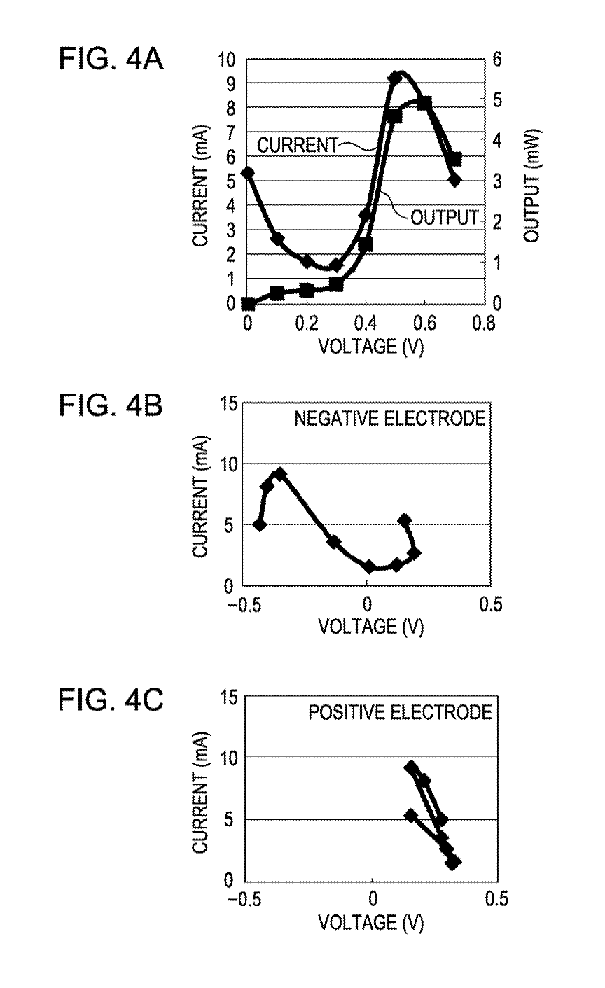

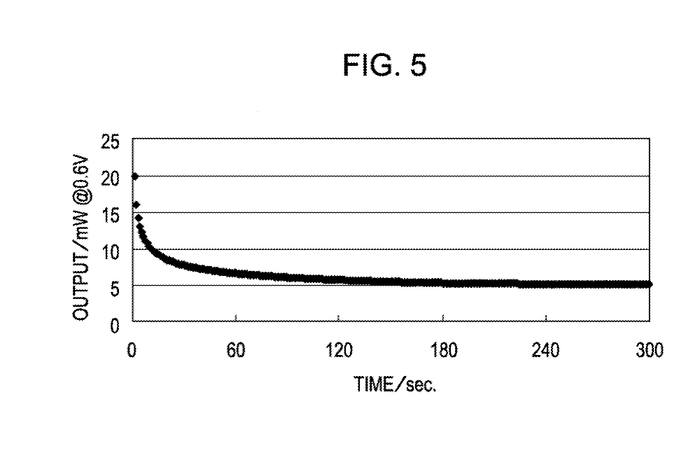

FIGS. 4A, 4B, and 4C show the measurement results of the output characteristics of the biofuel cell, the negative electrode 15, and the positive electrode 13, respectively. FIG. 5 shows the measurement results of changes with time in output (voltage of 0.6 V) of the biofuel cell. FIG. 5 shows that the output is initially 20 mW and is 5 mW after the passage of 300 seconds (5 minutes).

### EXAMPLE 2

A biofuel cell was assembled and the output characteristics thereof were evaluated. Although a porous carbon electrode was used for each of the positive electrode 13 and the negative electrode 15 in the biofuel cell of Example 1, a pellet electrode was used for each of the positive electrode 13 and the negative electrode 15 in the biofuel cell of Example 2. The pellet electrode was formed by mixing, using an agate mortar, KB (Ketjenblack), polyvinyl fluoride, an enzyme, a coenzyme, an electron mediator, and a polymer solution, drying the resultant mixture, and then pressing the mixture into a circular shape having a diameter of 15 mm. The components (enzyme, coenzyme, electron mediator, and polymer solution) which were immobilized on the positive electrode 13 and the negative electrode 15 were the same as in Example 1, and the amounts thereof were also the same as in Example 1. The thickness of the pellet electrode used as the positive electrode 13 was 0.66 mm, and the thickness of the pellet electrode used as the negative electrode 15 was 0.33 mm. The other properties of the biofuel cell of Example 2 were the same as the biofuel cell of Example 1.

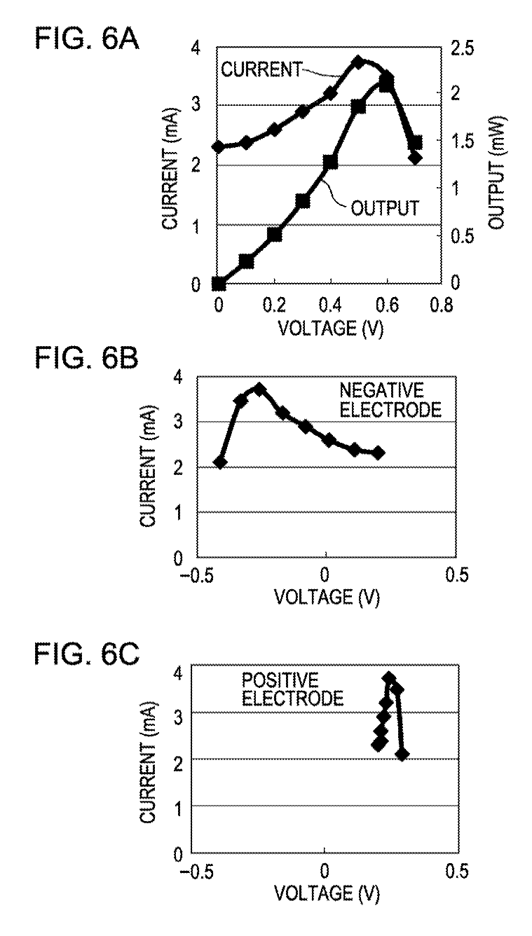

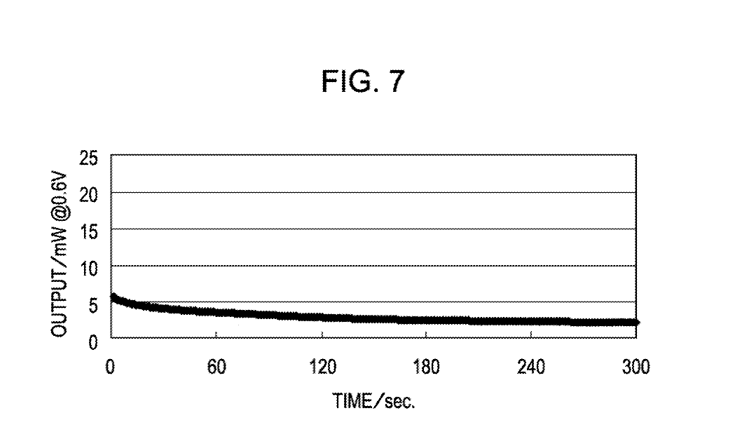

FIGS. 6A, 6B, and 6C show the measurement results of the output characteristics of the biofuel cell, the negative electrode 15, and the positive electrode 13, respectively. FIG. 7 shows the measurement results of changes with time in output (voltage of 0.6 V) of the biofuel cell. FIG. 7 shows that the output is initially 5 mW and is 2 mW after the passage of 300 seconds (5 minutes).

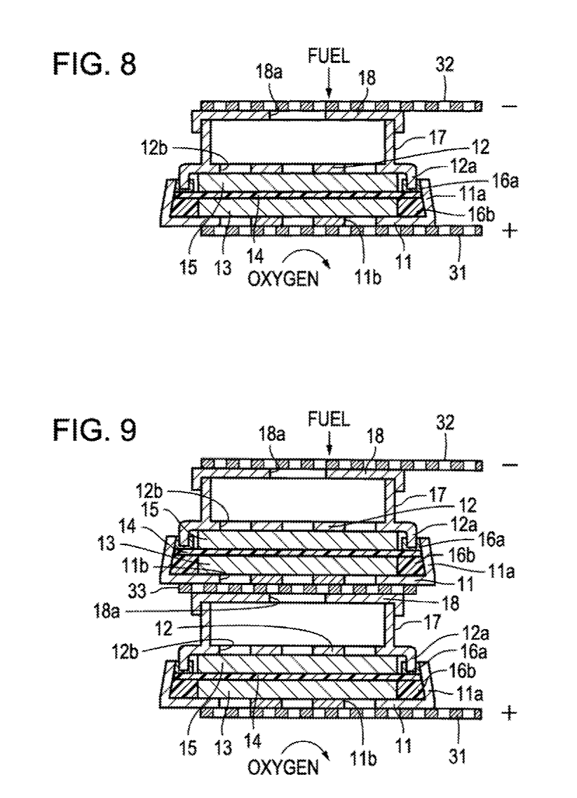

As shown in FIG. 8, mesh electrodes 31 and 32 may be formed on the positive electrode current collector 11 and the negative electrode current collector 12, respectively, in the biofuel cell. In this case, outside air enters the oxidizer supply ports 11b of the positive electrode current collector 11 through holes of the mesh electrode 31, and fuel enters the fuel tank 17 from the fuel supply port 18a of the cover 18 through holes of the mesh electrode 32.

FIG. 9 shows a case in which two biofuel cells are connected in series. In this case, a mesh electrode 33 is sandwiched between the positive electrode current collector 11 of one (in the drawing, the upper biofuel cell) of the biofuel cells and the cover 18 of the other biofuel cell (in the drawing, the lower biofuel cell). Therefore, outside air enters the oxidizer supply ports 11b of the positive electrode current collector 11 through holes of the mesh electrode 33. The fuel may be supplied using a fuel supply system.

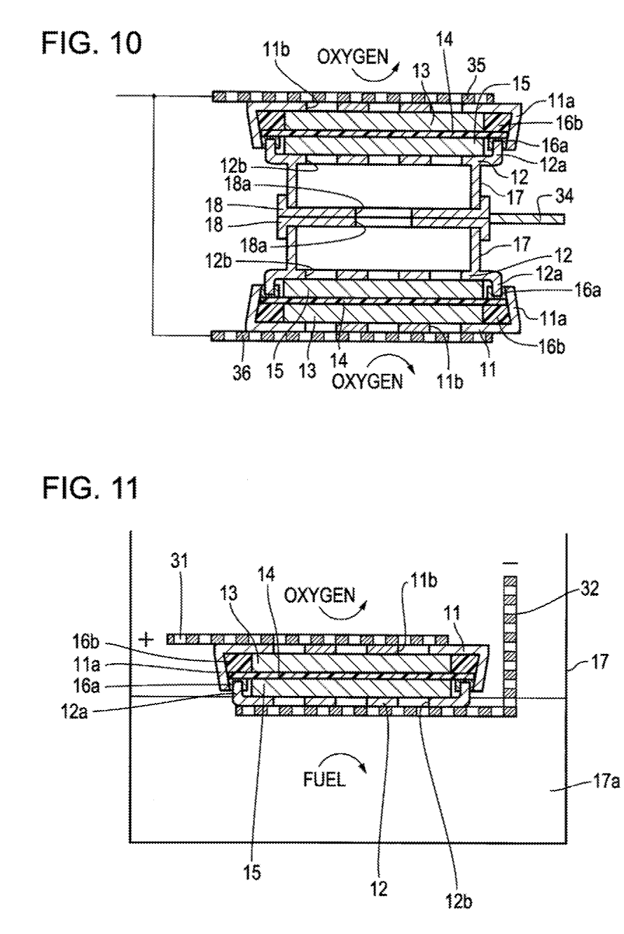

FIG. 10 shows a case in which two biofuel cells are connected in parallel. In this case, the fuel tank 17 of one (in the drawing, the upper biofuel cell) of the two biofuel cells and the fuel tank 17 of the other biofuel cell (in the drawing, the lower biofuel cell) were brought into contact with each other so that the fuel supply ports 18a of the covers 18 coincide with each other, and an electrode 34 is drawn out from the sides of the fuel tanks 17. In addition, mesh electrodes 35 and 36 are formed on the positive electrode current collector 11 of one of the biofuel cells and the positive electrode current collector 11 of the other biofuel cell. These mesh electrodes 35 and 36 are connected to each other. Outside air enters the oxidizer supply ports 11b of the positive electrode current collectors 11 through holes of the mesh electrodes 35 and 36.

As described above, in accordance with the first embodiment, the positive electrode 13, the proton conductor 14, and the negative electrode 15 are sandwiched between the positive electrode current collector 11 and the negative electrode current collector 12, and the edge of the outer periphery 11a of the positive electrode current collector 11 is caulked to the outer periphery 12a of the negative electrode current collector 12 through the gasket 16, thereby forming the coin- or button-like biofuel cell excluding the fuel tank 17. In the biofuel cell, the components are uniformly bonded together, thereby preventing variation in output and leakage of the cell solution such as the fuel and the electrolyte from the interfaces between the respective components. In addition, the biofuel cell is manufactured by a simple manufacturing process and is easily reduced in size. Further, the biofuel cell uses the glucose solution and starch as fuel, and about pH 7 (neutral) is selected as the pH of the electrolyte used. Therefore, the biofuel cell is safe even if the fuel and the electrolyte leak to the outside.

Further, in an air cell which is currently put into practical use, fuel and an electrolyte may be added during manufacture, thereby causing difficulty in adding the fuel and electrolyte after manufacture. However, in the biofuel cell, the fuel and electrolyte may be added after manufacture, thereby facilitating the manufacture as compared with an air cell which is currently put into practical use.

Next, a biofuel cell according to a second embodiment will be described.

As shown in FIG. 11, in accordance with the second embodiment, the fuel tank 17 provided integrally with the negative electrode current collector 12 is removed from the biofuel cell according to the first embodiment. In addition, the mesh electrodes 31 and 32 are used as the positive electrode current collector 11 and the negative electrode current collector 12, respectively, so that when used, the fuel cell floats on the fuel 17a charged in an open fuel tank 17 with the negative electrode 15 disposed on the lower side and the positive electrode 13 disposed on the upper side.

The other characteristics of the second embodiment are the same as in the first embodiment as long as properties are adversely affected.

In accordance with the second embodiment, the same advantages as those of the first embodiment may be obtained.

Next, a biofuel cell according to a third embodiment will be described. Although the biofuel cell according to the first embodiment is a coin or button type, the biofuel cell of the third embodiment is a cylindrical type.

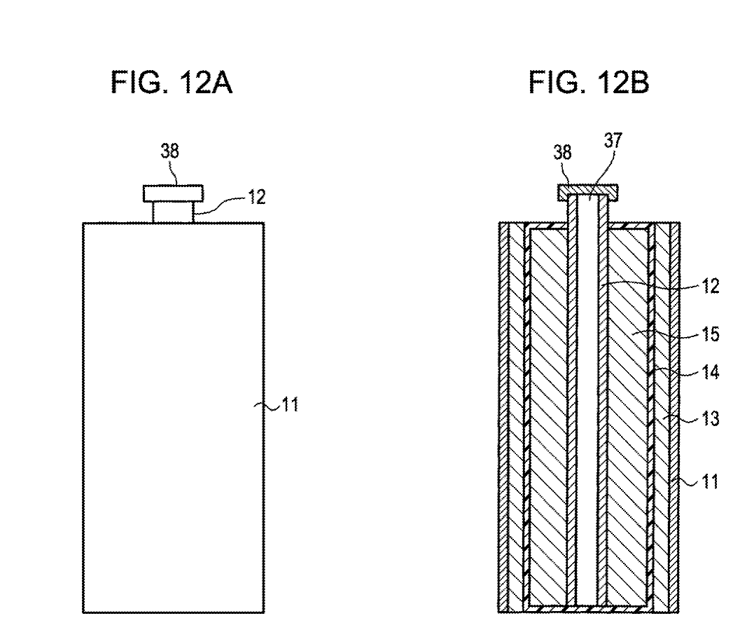

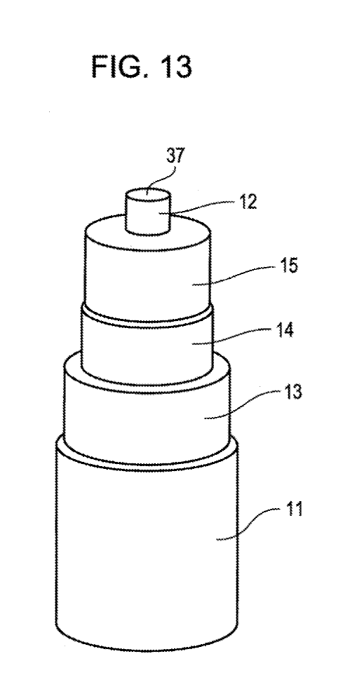

FIGS. 12A, 12B, and 13 show the biofuel cell. FIGS. 12A and 12B are a front view and a longitudinal sectional view, respectively, of the biofuel cell, and FIG. 13 is an exploded perspective view showing the components of the biofuel cell.

As shown in FIGS. 12A, 12B, and 13, in the biofuel cell, cylindrical negative electrode current collector 12, negative electrode 15, proton conductor 14, positive electrode 13, and positive electrode current collector 11 are provided in order on the outer periphery of a cylindrical fuel holding portion 37. In this case, the fuel holding portion 37 includes a space surrounded by the cylindrical negative electrode current collector 12. An end of the fuel holding portion 37 projects outward, and a cover 38 is provided on the end. Although not shown in the drawings, a plurality of fuel supply ports 12b is formed over the entire surface of the negative electrode current collector 12 provided on the outer periphery of the cylindrical fuel holding portion 37. In addition, the proton conductor 14 is formed in a bag shape which wraps the negative electrode 15 and the negative electrode current collector 12. The gap between the proton conductor 14 and the negative electrode current collector 12 at an end of the fuel holding portion 37 is sealed with, for example, a sealing member (not shown) so as to prevent fuel leakage form the gap.

In the biofuel cell, a fuel and electrolyte are charged in the fuel holding portion 37. The fuel and electrolyte pass through the fuel supply ports 12b of the negative electrode current collector 12, reach the negative electrode 15, and permeates into voids of the negative electrode 15 to be stored in the negative electrode 15. In order to increase the amount of the fuel stored in the negative electrode 15, the porosity of the negative electrode 15 is preferably, for example, 60% or more, but is not limited to this.

In the biofuel cell, a vapor-liquid separation layer may be provided on the outer periphery of the positive electrode current collector 11 in order to improve durability. As a material for the vapor-liquid separation layer, for example, a waterproof moisture-permeable material (a composite material of polyurethane polymer and a stretched polytetrafluoroethylene film), e.g., Gore-Tex (trade name) manufactured by WL Gore & Associates, may be used. In order to uniformly bond together the components of the biofuel cell, preferably, stretchable rubber (may be a band or sheet) having a network structure permeable to outside air is wound inside or outside the vapor-liquid separation layer, for compressing the whole of the components of the biofuel cell.

The other characteristics of the third embodiment are the same as in the first embodiment as long as properties are adversely affected.

In accordance with the third embodiment, the same advantages as those of the first embodiment may be obtained.

### EXAMPLE 3

A biofuel cell was assembled and the output characteristics thereof were evaluated. The same porous carbon electrode as in Example 1 was used as each of the positive electrode 13 and the negative electrode 15, and the porous carbon electrode was formed in a cylindrical shape. The cylindrical porous carbon electrode used as the positive electrode 13 had a diameter of 15 mm and a height (length) of 5 cm. The same components (the enzyme, coenzyme, electron mediator, and polymer) immobilized on the positive electrode 13 and the negative electrode 15 as in Example 1 were used in the same amounts as in Example 1. The other characteristics of the biofuel cell of Example 3 were the same as those of the biofuel cell of Example 1.

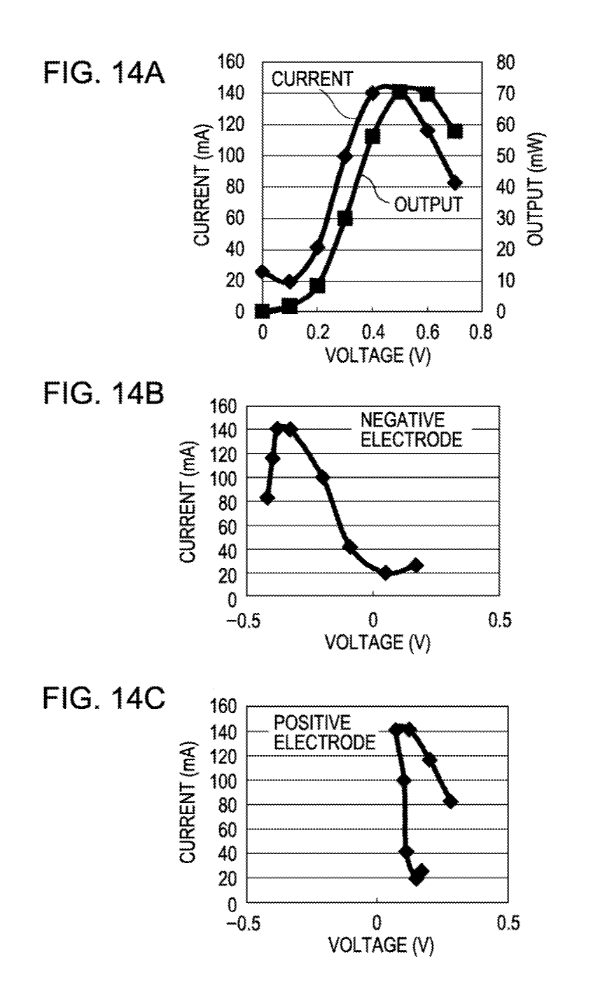

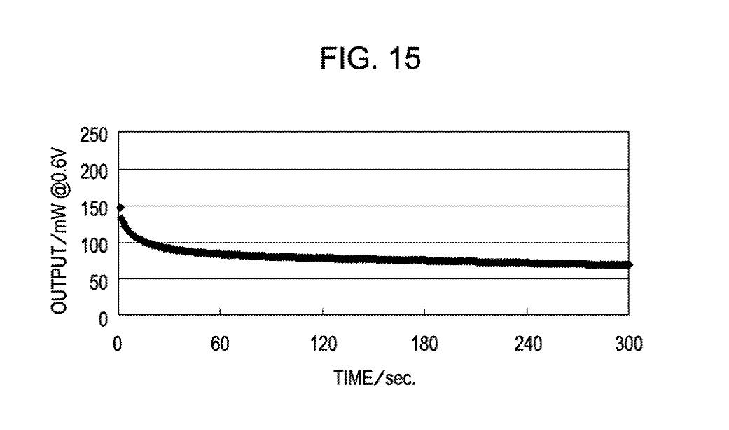

FIGS. 14A, 14B, and 14C show the measurement results of the output characteristics of the biofuel cell, the negative electrode 15, and the positive electrode 13, respectively. FIG. 15 shows the measurement results of changes with time in output (voltage of 0.6 V) of the biofuel cell. FIG. 15 shows that the output is initially 150 mW and is as high as 70 mW after the passage of 300 seconds (5 minutes).

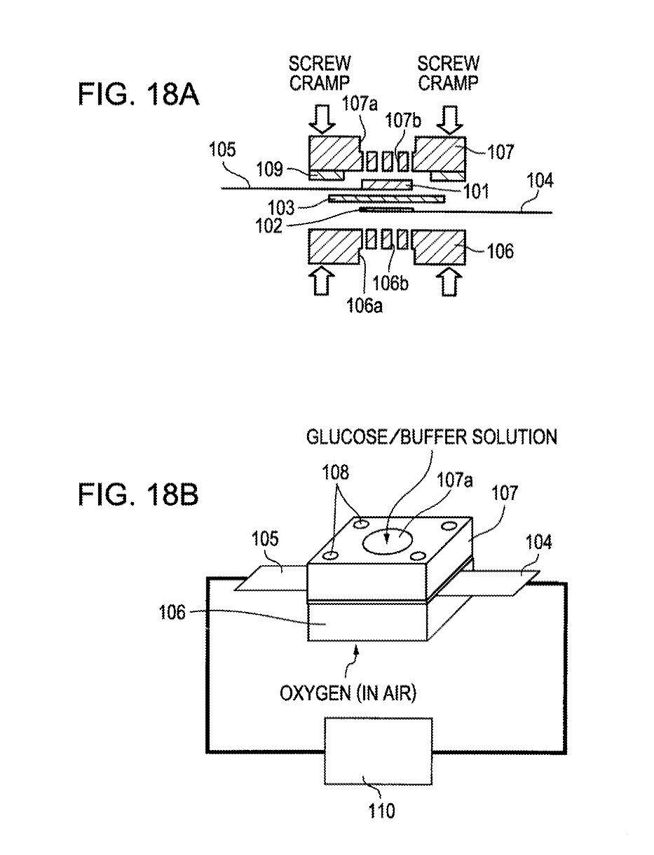

Description is now made of an example of results of comparison of output density between the coil- or button-shaped biofuel cell according to the first embodiment, the cylindrical biofuel cell according to the third embodiment, and the general stacked biofuel cell shown in FIGS. 18A and 18B. The results are shown in Table 1. Table 1 also shows the volume, the amount of fuel, and the fuel volumetric ratio (ratio of the fuel volume to the volume of the biofuel cell) of each of the biofuel cells.

TABLE 1
Volumetric efficiency of biofuel cell

| | Related art (stacked) | Coin type | Cylindrical type |
|---|---|---|---|
| Volume | 30 cc | 1.5 cc | 10 cc |
| Fuel | 7 cc | 1 cc | 8 cc |
| Volumetric ratio | 23% | 67% | 80% |
| of fuel | | | |
| Output | 100 mW | 4 mW | 70 mW |
| Output density | 3.3 mW/cm³ | 2.6 mW/cm³ | 7 mW/cm³ |

Table 1 indicates that the output density of the cylindrical biofuel cell according to the third embodiment is about twice as high as that of the general stacked biofuel cell. It is thus found that the volumetric efficiency of the cylindrical biofuel cell according to the third embodiment is very high.

Next, a biofuel cell according to a fourth embodiment will be described.

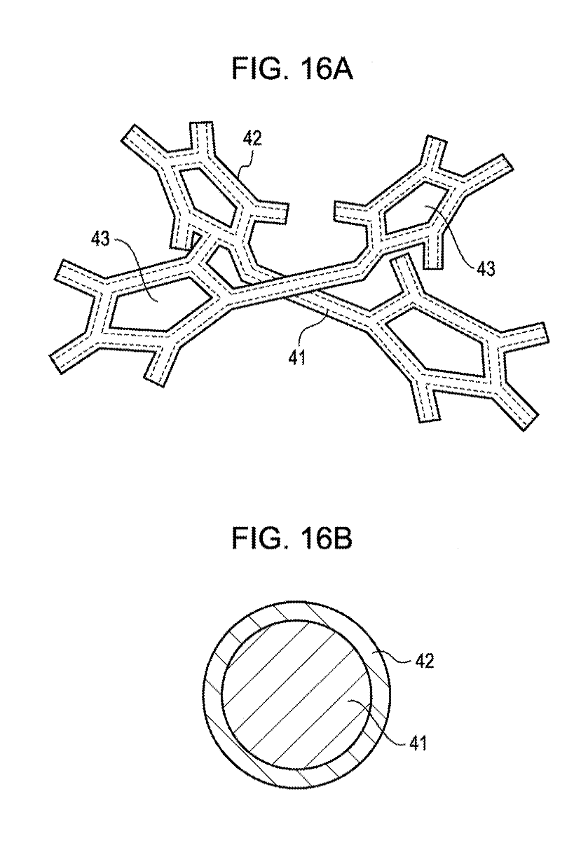

The biofuel cell according to the fourth embodiment has the same configuration as the biofuel cell according to the first, second, or third embodiment except that a porous conductive material as shown in FIGS. 16A and 16B is used as an electrode material of the negative electrode 15.

FIG. 16A schematically shows a structure of the porous conductive material, and FIG. 16B is a sectional view of a skeleton of the porous conductive material. As shown in FIGS. 16A and 16B, the porous conductive material includes a skeleton 41 composed of a porous material with a three-dimensional network structure, and a carbon-based material 42 coating the surface of the skeleton 41. The porous conductive material has a three-dimensional network structure in which many holes 43 surrounded by the carbon-based material 42 correspond to meshes. In this case, the holes 43 communicate with each other. The carbon-based material 42 may be any one of forms, such as a fibrous form (needle-like), a granular form, and the like.

The skeleton 41 composed of the porous material may be made of a foamed metal or foamed alloy, for example, foamed nickel. The porosity of the skeleton 41 is generally 85% or more and more generally 90% or more, and the pore size is generally, for example, 10 nm to 1 mm, more generally 10 nm to 600 μm, still more generally 1 to 600 μm, typically 50 to 300 μm, and more typically 100 to 250 μm. As the carbon-based material 42, for example, a high-conductivity material such as Ketjenblack is preferred, but a functional carbon material such as carbon nanotubes, fullerene, or the like may be used.

The porosity of the porous conductive material is generally 80% or more and more generally 90% or more, and the pore size is generally, for example, 9 nm to 1 mm, more generally 9 nm to 600 μm, still more generally 1 to 600 μm, typically 30 to 400 μm, and more typically 80 to 230 μm.

Next, a method for producing the porous conductive material will be described.

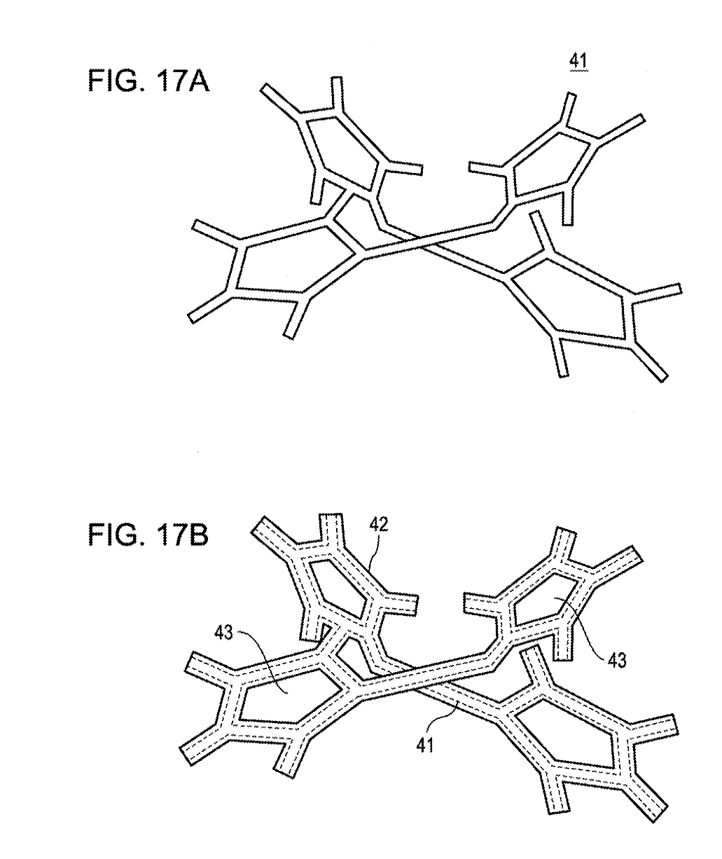

As shown in FIG. 17A, the skeleton 41 composed of a foamed metal or a foamed alloy (e.g., foamed nickel) is prepared.

Next, as shown in FIG. 17B, the surface of the skeleton 41 composed of a foamed metal or foamed alloy is coated with the carbon-based material 42. As the coating method, a general coating method may be used. For example, an emulsion containing carbon powder and an appropriate binder is sprayed on the surface of the skeleton 41 using a spray to coat the surface with the carbon-based material 42. The coating thickness of the carbon-based material 42 is determined according to the porosity and pore size desired for the porous conductive material in consideration of the porosity and pore size of the skeleton 42 composed of a foamed metal or foamed alloy. The coating is performed so that many holes 43 surrounded by the carbon-based material 42 communicate with each other.

As a result, the intended porous conductive material is produced.

The other characteristics are the same as in the first, second, or third embodiment.

According to the fourth embodiment, in addition to the same advantages as those of the first, second, or third embodiment, the advantages described below are obtained. Namely, the porous conductive material including the skeleton 41 composed of a foamed metal or foamed alloy with the surface coated with the carbon-based material 42 has sufficiently large holes 43, a rough three-dimensional network structure, high strength, high conductivity, and a sufficiently high surface area. Therefore, when the porous conductive material is used as an electrode material, an enzyme metabolism reaction is effected with high efficiency on the negative electrode 15 including an enzyme/coenzyme/electron mediator immobilized electrode, which is obtained by immobilizing an enzyme, a coenzyme, an electron mediator on the electrode material. Alternatively, an enzyme reaction phenomenon taking place near the electrode may be efficiently captured as an electrical signal. In addition, it may be possible to realize a biofuel cell with high performance and safety regardless of operation environments.

Next, a biofuel cell according to a fifth embodiment will be described.

The biofuel cell uses starch which is a polysaccharide as a fuel. In addition, glucoamylase which is a catabolic enzyme decomposing starch into glucose is also immobilized on the negative electrode 15 in association with the use of starch as the fuel.

In the biofuel cell, when starch is supplied as the fuel to the negative electrode 15, the starch is hydrolyzed into glucose with glucoamylase, and the glucose is decomposed with glucose dehydrogenase. Further, NAD⁺ is reduced in association with oxidation reaction in the decomposition process to produce NADH which is separated into two electrons, NAD⁺, and H⁺ by oxidation with diaphorase. Therefore, two electrons and two H⁺ are produced in one step of oxidation reaction per molecular of glucose, and four electrons and four H⁺ in total are produced in two steps of oxidation reaction. The thus-produced electrons are transferred to the negative electrode 15, and H⁺ moves to the positive electrode 13 through the proton conductor 14. On the positive electrode 13, H⁺ reacts with oxygen supplied from the outside and the electrons supplied from the negative electrode 15 through an external circuit to produce H₂O.

The other characteristics of the fifth embodiment are the same as the biofuel cell according to the first, second, or third embodiment.

In accordance with the fifth embodiment, the same advantages as those of the first, second, or third embodiment may be obtained. In addition, it may be possible to obtain the advantage that since starch is used as the fuel, the amount of electricity generated is increased as compared with when glucose is used as fuel.

Next, a biofuel cell according to a sixth embodiment will be described.

In the biofuel cell, the negative electrode 15 is composed of, for example, porous carbon, and an enzyme involved in decomposition of glucose, a coenzyme (e.g., NAD⁺ or the like) producing a reduced form in association with an oxidation reaction in the glucose decomposition process, a coenzyme oxidase (e.g., diaphorase) which oxidizes the reduced form of the coenzyme (e.g., NADH or the like), an electron mediator (e.g., ANQ, AMNQ, or VK3) which receives, from the coenzyme oxidase, electrons produced in association with oxidation of the coenzyme and supplies the electrons to the electrode, and a phospholipid or its derivative (e.g., DMPC) or a polymer thereof serving as an output increasing agent or an electron mediator diffusion promoter are immobilized on the electrode by an immobilization material (not shown) (e.g., a polyion complex formed using polycation, such as poly-L-lysine (PLL), and polyanion, such as sodium polyacrylate (PAAcNa).

In accordance with the fifth embodiment, besides the enzyme involved in decomposition of glucose, the coenzyme producing a reduced form in association with an oxidation reaction in the glucose decomposition process, the coenzyme oxidase which oxidizes the reduced form of the coenzyme, and the electron mediator, the phospholipid or its derivative or a polymer thereof is immobilized as the output increasing agent or the electron mediator diffusion promoter on the negative electrode 15. Therefore, for example, the electron mediator easily diffuses in and near the electrode, and thus the enzyme, the coenzyme, the coenzyme oxidase, and the electron mediator are easily uniformly mixed, thereby maintaining or increasing the concentration of the electron mediator near the electrode. As a result, the function of the electron mediator is sufficiently exhibited, thereby permitting the supply of more electrons to the electrode and a significant increase in output of the biofuel cell.

Although the embodiments are described in detail above, these embodiments should not be construed as limiting and various modifications may be made on the basis of the technical idea.

For example, the numerical values, structures, configurations, shapes, and materials given in the above-described embodiments are only examples, and different numerical values, structures, configurations, shapes, and materials may be used according to demand.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A fuel cell comprising:
a positive electrode and a negative electrode which are opposed to each other with a proton conductor provided therebetween; and
an enzyme immobilized as a catalyst on at least one of the positive electrode and the negative electrode,
wherein the positive electrode, the proton conductor, and the negative electrode are accommodated in a space formed between a positive electrode current collector having a structure permeable to an oxidizer and a negative electrode current collector having a structure permeable to fuel.

2. The fuel cell according to claim 1, wherein the edge of one of the positive electrode current collector and the negative electrode current collector is caulked to the other of the positive electrode current collector and the negative electrode current collector through an insulating sealing member to form the space.

3. The fuel cell according to claim 1, wherein the positive electrode current collector has an oxidizer supply port, and the negative electrode current collector has a fuel supply port.

4. The fuel cell according to claim 1, wherein the negative electrode current collector includes a fuel holding portion.

5. The fuel cell according to claim 1, wherein an electron mediator in addition to the enzyme is immobilized on at least one of the positive electrode and the negative electrode.

6. The fuel cell according to claim 1, wherein the enzyme is immobilized on the negative electrode, and the enzyme includes an oxidase which promotes oxidation of a monosaccharide and decomposes the monosaccharide.

7. The fuel cell according to claim 6, wherein the enzyme includes a coenzyme oxidase which returns a coenzyme reduced in association with the oxidation of the monosaccharide to an oxidized form and which supplies electrons to the negative electrode through an electron mediator.

8. The fuel cell according to claim 7, wherein the oxidized form of the coenzyme is NAD⁺, and the coenzyme oxidase is diaphorase.

9. The fuel cell according to claim 6, wherein the oxidase is NAD⁺-dependent glucose dehydrogenase.

10. The fuel cell according to claim 1, wherein the enzyme is immobilized on the negative electrode, and the enzyme includes a catabolic enzyme which promotes decomposition of a polysaccharide to produce a monosaccharide and an oxidase which promotes oxidation of a monosaccharide and decomposition thereof.

11. The fuel cell according to claim 10, wherein the catabolic enzyme is glucoamylase, and the oxidase is NAD⁺-dependent glucose dehydrogenase.

12. A method for manufacturing a fuel cell including a positive electrode and a negative electrode which are opposed to each other with a proton conductor provided therebetween, and an enzyme immobilized as a catalyst on at least one of the positive electrode and the negative electrode, the method comprising:
sandwiching the positive electrode, the proton conductor, and the negative electrode between a positive electrode current collector having a structure permeable to an oxidizer and a negative electrode current collector having a structure permeable to fuel; and
caulking the edge of one of the positive electrode current collector and the negative electrode current collector to the other of the positive electrode current collector and the negative electrode current collector through an insulating sealing member.

13. The method according to claim 12, wherein one of the positive electrode current collector and the negative electrode current collector has a cylindrical shape with an open end.

14. A fuel cell comprising:
a positive electrode and a negative electrode which are opposed to each other with a proton conductor provided therebetween; and
an enzyme immobilized as a catalyst on at least one of the positive electrode and the negative electrode,
wherein the negative electrode, the proton conductor, the positive electrode, and a positive electrode current collector having a structure permeable to an oxidizer are provided in order around a predetermined central axis, and
a negative electrode current collector having a structure permeable to fuel is provided to be electrically connected to the negative electrode.

15. The fuel cell according to claim 14, further comprising a columnar fuel holding portion provided on the predetermined central axis.

16. An electronic apparatus comprising:
one or a plurality of fuel cells at least one of which includes a positive electrode and a negative electrode opposed to each other with a proton conductor provided therebetween, and an enzyme immobilized as a catalyst on at least one of the positive electrode and the negative electrode,
wherein the positive electrode, the proton conductor, and the negative electrode are accommodated in a space formed between a positive electrode current collector having a structure permeable to an oxidizer and a negative electrode current collector having a structure permeable to fuel.

17. An electronic apparatus comprising:
one or a plurality of fuel cells at least one of which includes a positive electrode and a negative electrode opposed to each other with a proton conductor provided therebetween, and an enzyme immobilized as a catalyst on at least one of the positive electrode and the negative electrode,
wherein the negative electrode, the proton conductor, the positive electrode, and a positive electrode current collector having a structure permeable to an oxidizer are provided in order around a predetermined central axis, and
a negative electrode current collector having a structure permeable to fuel is provided to be electrically connected to the negative electrode.
